(19) United States
(12) Patent Application Publication
(10) Pub. No.: US 2014/0289096 A1
(43) Pub. Date: Sep. 25, 2014

(54) SYSTEMS AND METHODS FOR PROVIDING SHARE ASSESSMENT DATA WITH COMPOUND QUALITY ANALYSIS

(71) Applicant: Skaffold Pty Limited, Pyrmont (AU)

(72) Inventor: Roger James Montgomery, Pyrmont (AU)

(21) Appl. No.: 14/348,831

(22) PCT Filed: Sep. 28, 2012
(86) PCT No.: PCT/AU12/01182

§ 371 Date: Mar. 31, 2014

(30) Foreign Application Priority Data
Sep. 29, 2011 (AU) 2011226954

(51) Int. Cl. G06Q 40/04

(52) U.S. Cl. CPC G06Q 40/04
USPC 705/37

(57) ABSTRACT

A computer-implemented method for providing share assessment data, the method including:
maintaining access to a repository of data for a plurality of shares in respective businesses, wherein the data includes, for each share:
   (c) one or more first inputs for deriving a first share quality rating component indicative of risk of an adverse liquidity event in each business; and
   (d) one or more second inputs for deriving a second share quality rating component indicative of financial performance of each business; and
combining the first and second share quality rating components thereby to define a compound share quality rating that is independently indicative of both liquidity risk and financial performance for each of the respective businesses;
wherein the compound share quality rating scale provides an assessment dimension for an axis of one or more charts.

### FIELD OF THE INVENTION

The present invention relates to systems and methods for providing share assessment data. Some embodiments of the invention have been particularly developed for assisting users to analyse and understand information relating to stocks, equities or shares and the underlying businesses, so as to make better informed choices in the acquisition and/or disposal of shares from the perspective of “value investing”. It should be appreciated, however, that the invention is not limited to this particular field of use, and is also applicable in other contexts.

### BACKGROUND

The following discussion of the prior art is intended to place the invention in an appropriate technical context and allow the potential advantages of it to be more fully understood. It should be appreciated, however, that any reference in this specification to prior art does not constitute an express or implied admission that such art is widely known or is common general knowledge in the relevant field.

In the field of business investment, various techniques and tools have been developed to assist in understanding the financial performance of businesses that are prospective targets for investment, and also to assist in predicting the future performance of those businesses, and ultimately their shares, equities or stocks. The majority of such techniques and tools are focused on predicting how the share price of a business on a particular stock market will move at some point in the future and therefore rely heavily on factors that are believed to influence the behaviour of the relevant stock, or stock market.

One popular technique is typically referred to as technical analysis or “charting”, whereby professional analysts or traders will evaluate how and when to trade into and out of particular shares or financial markets based on price movements within these markets. This is usually done using pattern-based concepts as “trendlines”, “trend channels”, “support and resistance” levels, “head and shoulder” formations and the like. These are typically reflected graphically in dedicated charts, and interpreted subjectively in combination with related technical indicators such as “historical price volatility”, “moving average convergence/divergence”, “directional movement” indices and the like.

A significant limitation with this approach is that it is based primarily on market-based measures such as share prices or price to earnings (P/E) ratios which are, at least to some extent, extrinsic to the underlying businesses and which are strongly influenced by prevailing market sentiment and perceptions. This in turn results in share price movements that are regularly decoupled from the performance of the underlying businesses in terms direction, magnitude and volatility.

The philosophy and technique of “value investing”, by contrast, places primary emphasis on the evaluation of intrinsic factors that are inherent in the businesses themselves such as earnings per share, return on equity, profitability, debt to equity, and the like. These factors can be analysed independently of the prevailing perceptions and sentiments of the stock market and short-term fluctuations in market pricing. The value investment philosophy is, however, predicated on the expectation that in the long term, the market price for stocks or shares in a business will eventually converge toward or oscillate around the “intrinsic value” of that business.

Hence, the primary objective behind the value investing technique is to establish an estimate of intrinsic value of a business, which may change over time as the business develops, and to acquire shares in the business at a market price that is substantially below that intrinsic value, on the expectation that in the medium to long term, price and intrinsic value will tend to converge. A refinement in the technique is to independently assess the intrinsic quality of businesses and to restrict investments to businesses that are not only trading at a discount to their intrinsic value, but are also of a high quality. This aspect is important because from a value investment perspective, there may be little point in buying shares that are relatively inexpensive if the poor quality of the underlying business does not ultimately justify a higher valuation. Conversely, the quality of superior businesses tends eventually to be reflected in the share price. Assessment of the intrinsic quality of a business can be based on a range of considerations and inputs, including for example inputs related to financial risk and performance.

There have hitherto been numerous software and other tools available to assist analysts, investors and fund managers involved in technical analysis, charting and other popular investment techniques of this type. However, because they are based on a fundamentally different investment philosophy or style (essentially analysing shares rather than businesses) with primary emphasis on extrinsic inputs, they are not readily adapted for use in the context of value investing.

It is an object of the present invention, at least in some embodiments, to overcome or substantially ameliorate one or more of the deficiencies of the prior art, or at least to provide a useful alternative.

### SUMMARY OF THE INVENTION

In a first aspect, the invention provides a computer-implemented method for providing share assessment data, the method including:
maintaining access to a repository of data for a plurality of shares in respective businesses, wherein the data includes, for each share:
   (a) one or more first inputs for deriving a first share quality rating component indicative of risk of an adverse liquidity event in each business; and
   (b) one or more second inputs for deriving a second share quality rating component indicative of financial performance of each business; and
combining the first and second share quality rating components thereby to define a compound share quality rating that is independently indicative of both liquidity risk and financial performance for each business.

In some embodiments, the first inputs include a parameter (A) indicative of a return on assets for the business associated with each share. Preferably, the first inputs also include a parameter (B) indicative of a ratio of total sales to total assets for the business associated with each share. In some embodiments, the first inputs also include a parameter (C) indicative of a debt to equity ratio for the business associated with each share.

In some embodiments, the first inputs are weighted, such that parameter (A) is weighted more heavily than parameter (B) and parameter (B) is weighted more heavily than parameter (C).

Preferably, the second inputs include a parameter (D) indicative of return on equity for the business associated with each share. Preferably, the second inputs include a parameter (E) indicative of cash return on assets for the business associated with each share. In some embodiments, the second inputs include a parameter (F) indicative of change in shares on issue over time for the business associated with each share. In some embodiments, the second inputs include a parameter (G) indicative of a debt to equity ratio for the business associated with each share.

In some preferred embodiments, the second inputs are weighted, such that parameter (D) is weighted more heavily than parameters (E) and (F).

In some embodiments, the first share quality rating component is defined relative to a first share quality rating scale and the second share quality rating component is defined relative to a second share quality rating scale. Preferably also, the compound share quality rating is defined relative to a compound share quality rating scale.

Preferably, the compound share quality rating scale provides an assessment dimension for an axis of one or more charts. In this case, the method preferably includes the step of generating a chart having an axis representative of the compound share quality rating scale.

In some embodiments, the compound share quality rating scale is graduated primarily on the basis of the first share quality rating and secondarily on the basis of the second share quality rating, such that the first share quality rating is weighted relatively more heavily than the second share quality rating.

In some embodiments, the compound share quality rating is displayed by a first symbolic identifier indicative of the risk of an adverse liquidity event in the business and a second symbolic identifier indicative of the financial performance of the business.

Preferably, for a given share, the first symbolic identifier is selected from a first set of potential symbolic identifiers, wherein each of the potential symbolic identifiers in the first set is associated with a predefined range of first share quality ratings. Preferably also, for a given share, the second symbolic identifier is selected from a second set of potential symbolic identifiers, wherein each of the potential symbolic identifiers in the second set is associated with a predefined range of second share quality ratings.

In some embodiments, one of the first and second symbolic identifiers is a letter and the other of the first and second symbolic identifiers is an integer. In one preferred form, the first symbolic identifier is a letter selected from a group comprising at least the letters A, B and C and the second symbolic identifier is a number selected from a group comprising at least the numbers 1, 2, 3, 4 and 5.

In some embodiments, one of the first and second symbolic identifiers is a symbol and the other of the first and second symbolic identifiers is a visual characteristic applied to that symbol. In one such form, the visual characteristic includes a colour.

In some embodiments, one of the first and second symbolic identifiers is a first symbol having a first visual characteristic, and the other of the first and second symbolic identifiers is a second symbol having a second visual characteristic. In one embodiment, the first and second visual characteristics include colour, determined on the basis of the respective first or second share quality rating components.

In some embodiments, the compound share quality rating is displayed to a user using the first symbolic identifier and the second symbolic identifier, and displayed on a chart using the first share quality rating and second share quality rating.

In some embodiments, the method includes the step of plotting, on a chart, the compound share assessment rating for a selection of the plurality of shares. Preferably, the chart plots the respective compound share assessment ratings for a selection of shares on one axis against corresponding share value ratings for the same selection of shares on another axis.

In a second aspect, the invention provides a computer program product for performing a method as described herein.

In a further aspect, the invention provides a non-transitive carrier medium for carrying computer executable code that, when executed on a processor, causes the processor to perform a method as described herein.

In yet another aspect, the invention provides a computer system configured for performing a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may do so. Furthermore, the particular features, structures or characteristics may be combined in any suitable manner, permutation and combination even if not explicitly disclosed, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms “comprising”, “comprised of” or “which comprises” is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms “including” or “which includes” or “that includes” as used herein is also an open term that means including at least the elements/features that follow the term, but not excluding others. Thus, including is synonymous with, and means the same as, comprising.

### BRIEF DESCRIPTION OF THE DRAWINGS

Embodiments of the invention will now be described, by way of example only, with reference to the accompanying drawings, in which:

FIG. 1 schematically illustrates a system according to one embodiment of the invention;

FIG. 2 illustrates a method according to one embodiment;

FIG. 3 illustrates we web-delivery framework according to one embodiment;

FIG. 4A illustrates a chart generated according to one embodiment; and

FIG. 4B illustrates a chart generated according to one embodiment.

FIG. 4C illustrates a chart generated according to one embodiment.

### DETAILED DESCRIPTION

Described herein are systems and methods for providing share assessment data. For example, one embodiment takes the form of a computer implemented method performed by a web server for delivering data to client terminals, thereby to enable the rendering of share assessment data in chart form. The web server provides a client interface (which is renderable in a client web browser), this interface being configured to display a plurality of charts. In overview, the charts include graphical markers respectively indicative of a plurality of shares, each marker having a visual feature indicative of a relationship between a share price rating and share quality rating for its respective share. For a given share, the graphical marker preferably retains the same visual feature(s) or at least one common indicative characteristic across the plurality of charts.

Other embodiments include related methodologies performed by client terminals, both in the context of executing web-delivered code from a web server, and in the context of executing local proprietary applications. Some embodiments include hardware components and/or carrier media associated with the implementation of such methodologies.

### Exemplary System

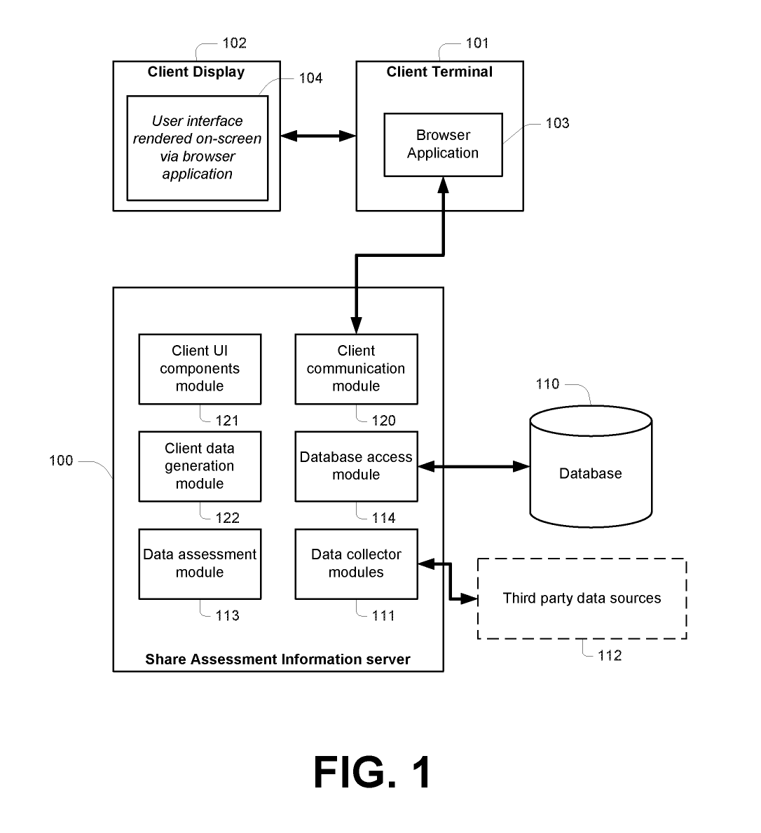

FIG. 1 illustrates an exemplary system whereby a share assessment information server 100 delivers computer executable code to a plurality of client terminals via the Internet. An exemplary client terminal 101 is illustrated in combination with an associated client display 102. A browser application 103 (such as Microsoft Internet Explorer or Google Chrome) executes on client terminal 101. Code delivered by server 100 is rendered via browser application 103 thereby to provide an on-screen rendering 104 of a client interface provided by server 100.

It should be appreciated that the example of a browser/server arrangement is exemplary only. In some embodiments, a proprietary application executes on terminal 101, that proprietary application including computer executable code for allowing terminal 101 to perform various functionalities of server 100 discussed below. For example, such an approach is in some cases preferable for mobile device applications, such as applications coded for iPhone or Android platforms.

In overview, server 100 is configured for performing various computer-implemented methods for providing share assessment data. In some cases, such a method includes maintaining access to a repository of data for a plurality of shares. In the context of FIG. 1, that data is maintained in database 110. As used herein, the expression “maintaining access” requires only that server 100 is able to access data in database 110 as needed. That is, the access need not be continuous; but may be periodic or spasmodic. In some cases database 110 is physically housed at a location remote of server 100 (optionally jurisdictionally remote). Additionally, it will be appreciated that server 100 and/or database 110 may be defined by a plurality of distributed components.

In the embodiment of FIG. 1, server 100 includes data collector modules 111 that are configured to obtain information from third party data sources 112. For example, modules 111 are configured to extract data from RSS feeds or the like, such that database 110 is able to be updated with new information. In the illustrated embodiment a data assessment module 113 receives data from collector modules 111 and processes that data into a form appropriate for input to database 110. A database access module 114 is configured to input the new data into database 110. Database access module 114 is additionally configured for performing other database operations, such as handling database queries and the like.

As foreshadowed above, server 100 is configured to provide a client interface for clients, such as client 101. In this regard, server 100 includes a client communication module 120, which is responsible for handling the delivery of data to clients, and the receipt of data from clients. For example, module 120 is configured for receiving data indicative of the interaction of a user of client terminal 101 with the client interface (as rendered on display 103). The received data is processed, for example to allow handling of requests for new pages, elements, objects, refreshed renderings, and so on. A client UI components module 121 is configured for defining UI components that are to be delivered to client terminal 101 via module 120. A client data generation module 122 is configured to generate specific data for display at client terminal 102, such as charts, diagrams, and the like. That is, at a general level, module 121 defines objects configured to contain data, and module 122 generates the data to be contained in those objects.

### Generation of Charts

Among a range of other functionalities, the client interface provided by server 100 and rendered at client terminal 101 is configured to display a plurality of charts (although not necessarily simultaneously; in some embodiments the charts may be displayed one at a time). The embodiments discussed herein are particularly focused on the generation and presentation of such charts.

In overview, for the charts considered herein, each chart provides information regarding a selection of the shares for which data is maintained in database 100. In some cases the selection is defined by all of the available shares for which data is stored. However, more preferably, one or more rules/filters are applied thereby to transform the full gamut of shares to a reduced selection. For example, one filter excludes all shares having zero intrinsic value, according to a predefined intrinsic valuation algorithm.

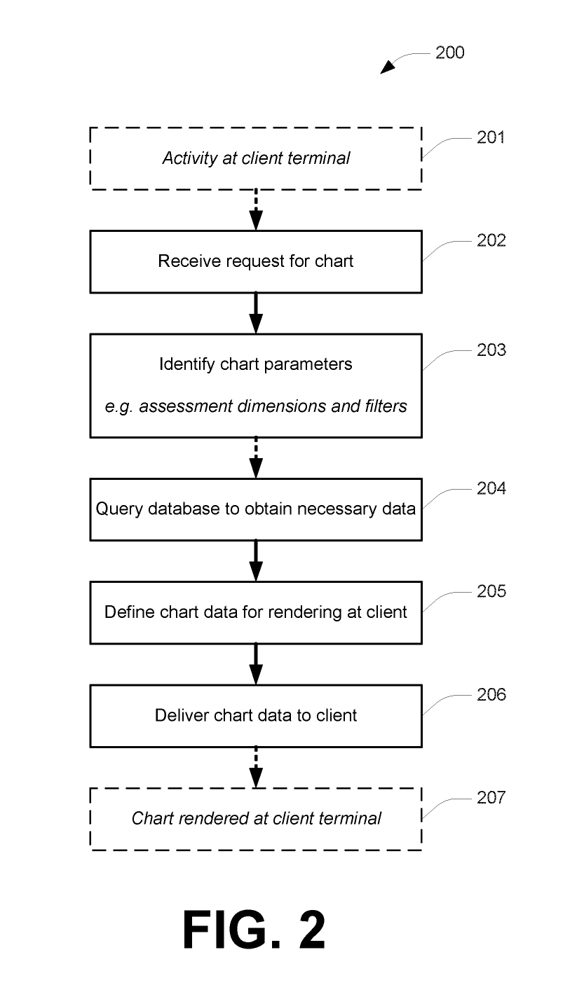

FIG. 2 illustrates a computer implemented method according to one embodiment, this method being performed in substance by server 100, thereby to allow a chart to be displayed at client terminal 101. In FIG. 2, functional blocks bordered by dashed lines represent processes performed by components other than server 100.

Functional block 201 represents a process whereby activity occurs at client terminal 101, specifically in terms of interaction between a user and the client interface which results in a request to display a chart. For example, this might include the user navigating to a page that is configured to display a particular chart. This results in a request for a chart being received by server 100 at 202. Server 100 then identifies chart parameters at 203. The term “chart parameters” describes factors such as assessment dimensions (for example an x-axis assessment dimension and y-axis assessment dimension in the context of a line chart or scatter chart) and filters (for example whether the chart is to display data for a single share, a defined group of shares meeting specific requirements, and so on). In some cases predefined sets of chart parameters are stored to simplify this process (for example the request may be to provide “chart type #1234”). Based on the chart parameters, server 100 conducts a query of database 110 (via module 114) at 204 thereby to obtain the data necessary to generate that chart. Module 122 is then operated at 205 to define data for rendering of the relevant chart at terminal 101, with this data being provided to terminal 101 at 206. Terminal 206 then renders the relevant chart at 207.

It will be appreciated that FIG. 2 is an exemplary method only, and that in other embodiments modified methods are used. For example, optimizations are optionally incorporated into the methodology thereby to reduce latency between client requests and chart data provision, and/or to allow an already-rendered chart to be updated with new data and/or parameters (such as filters).

In some cases, for each of the selections of the shares that are to be displayed in a chart, respective graphical markers are used to illustrate the attributes of each share in the selection relative to a set of assessment dimensions. For example, the chart may be a scatter chart, and a graphical marker (such as a dot, cross, or the like) is used to identify the position of each share on the chart relative to the assessment dimensions (which are displayed on the x-axis and y-axis).

Preferably, each graphical marker includes a link to a page or object provided by the client interface that displays additional information regarding the share to which that graphical marker relates. That is, by clicking on a graphical marker, a user is provided with additional “drill-down” information concerning the relevant share (optionally including access to further share-specific charts). In some cases the client interface is configured such that hovering a cursor over a given marker provides “pop-up” information (such as company name, key financial statistics and the like).

### Share Price Ratings and Share Quality Ratings

Database 110 includes a range of information regarding the plurality of shares. The extent of information varies between embodiments. However, for the purposes of various embodiments considered herein, the following two forms of data are required:

(a) data indicative of a share price rating; and
(b) data indicative of a share quality rating.

In some cases database 110 specifically maintains, for each share, the share price rating and share quality rating (which may be recalculated periodically, optionally with storage of past and/or projected values). In other cases the database only maintains data from which the share price rating and share quality rating are calculated, and those ratings are calculated by server 100 on demand.

The term “share price rating” is used herein to describe a rating related to the price of a share. In some embodiments the share price rating is related to the intrinsic value of a share (a value calculated by considering various intrinsic factors concerning a company to which a share relates) and the extrinsic value of a share (for example the market-based share price). The share price rating is preferably based on a comparison of the intrinsic and extrinsic values. At a general level, it will be appreciated that where the intrinsic value is greater than the extrinsic value, that might indicate that the share is underpriced, indicating that the share could be considered suitable for acquisition, or at least further analysis, under the value investing framework. Conversely, where the extrinsic value (i.e. market price) is greater than the intrinsic value, that might indicate that the share is overpriced, indicating that the share might not be considered suitable for acquisition, in the absence of some overriding consideration. In some embodiments the extrinsic value and intrinsic values are compared to calculate a specific share price rating in to the form of a “Margin of Safety” (MOS). Margin of safety in this context refers essentially to the margin for error in terms of the value investment objective of acquiring shares (in high-quality businesses) that are priced at a discount to their intrinsic value.

For example, if the intrinsic share value is 20% greater than the extrinsic share value (i.e. the prevailing share price), an indicative MOS calculation protocol results in a +20% MOS for that share. Likewise, if the intrinsic share value is 60% lower than the extrinsic share value, that results in a −60% MOS for that share. It will be appreciated that this MOS approach provides a useful origin for a chart axis. That is, by plotting MOS as an assessment dimension on one axis of a chart, the zero point on that axis separates overpriced shares from underpriced shares.

It should be appreciated that the specific inputs, algorithms and formulae used to calculate intrinsic values, extrinsic values, and share price ratings vary between embodiments. The technologies and methodologies described herein are independent of such specifics; only the resulting share price rating is required.

The term “share quality rating” is used herein to describe a rating related to the quality of a share, or more accurately to the intrinsic quality of the underlying business. This may be calculated using a range of inputs, including but not limited to inputs indicative of the financial integrity or health of the business based, for example, on factors or predefined threshold levels indicative of the likelihood of insolvency or default on loans. Such inputs may be derived with reference to metrics such as debt to equity ratio, return on equity, and the like. The share quality rating may additionally or alternatively incorporate inputs indicative of measures linked to sustainability of competitive advantage based on assessment of barriers to entry in the relevant market, and similar factors. The share quality rating may also (additionally or alternatively) include inputs indicative of the financial performance of the underlying business. Inputs of this type may, for example, be based on financial metrics such as earnings per share, return on equity, profitability and the like, as well as trends in such metrics based on analysis of historical and/or projected future performance of the business.

As with the share price rating, it should be appreciated that the specific inputs, algorithms and formulae used to calculate share quality ratings vary between embodiments, and will be readily understood by those skilled in the art. The technologies and methodologies described herein are independent of such specifics. Only the resulting share quality rating is required (and this may be a relative value, optionally defined with respect to a defined origin so as to distinguish in relative terms between “good quality” and “poor quality” in relation to a specific metric or set of metrics, whether qualitatively or quantitatively derived, and whether internally generated or externally sourced). It will thus be appreciated that the term “quality” in this context is intended to be broadly interpreted.

### Share Price Ratings and Share Quality Ratings in Charts

As noted above, for each selection of shares to be displayed in a chart, respective graphical markers are used to illustrate the attributes of each share in the selection relative to a set of assessment dimensions. For example, the chart may be a scatter chart, and a graphical marker (such as a dot, cross, or the like) is used to identify the position of each share on the chart relative to the assessment dimensions (which are displayed on the x-axis and y-axis).

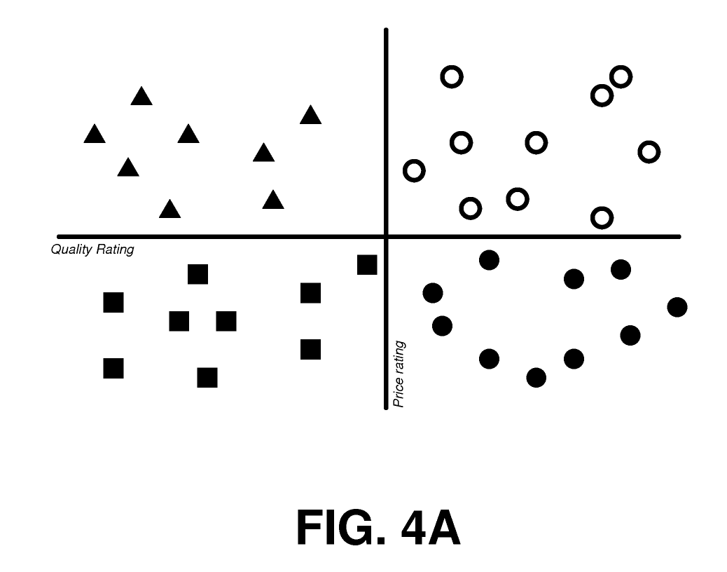

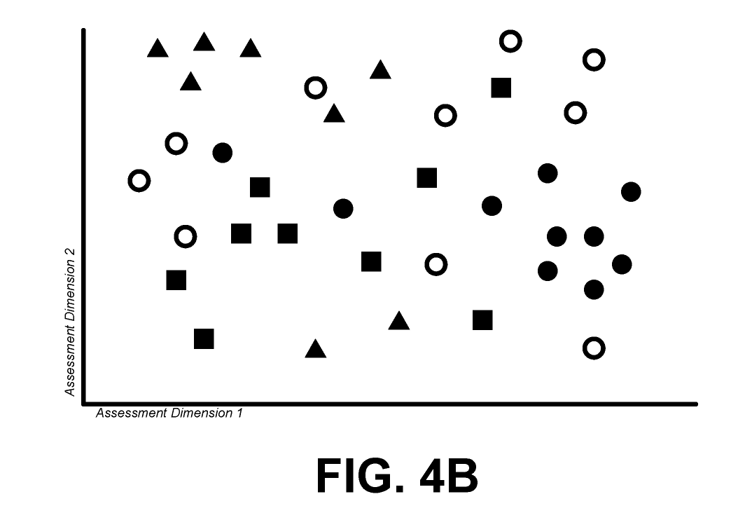

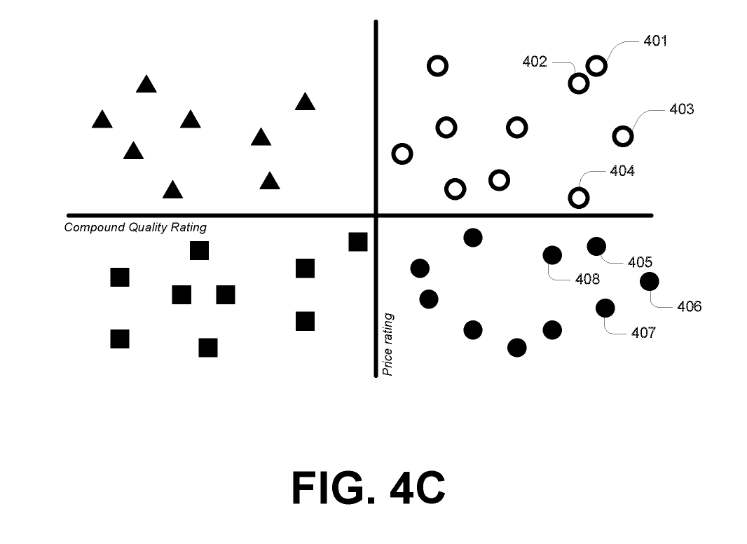

In one embodiment, for each share, the graphical marker has a visual feature determined by the relationship between the share price rating and share quality rating. Accordingly, it is possible for a viewer to ascertain information about the relationship between a given share's price rating and quality rating based on a visual feature of the marker, as opposed to the position of that marker on the chart. The nature of the visual feature(s) varies between embodiments. Preferably colour is used. However, in the black and white examples of FIGS. 4A and 4B, marker shapes are used for the sake of clear illustration. Other visual features may be based upon shading, opacity, alphanumeric marking, animation, and so on. Additional axes or dimensions may also be used. It will be appreciated that some features, such as colour, allow for a graduated progression between visual features (for example graduated progression though the spectrum of colours) or stepwise progression (for example using only certain colours, whereas other features allow only for stepwise progression (such as the shapes of FIG. 4A and FIG. 4B). In any event, the crux of the matter is that a viewer of a chart is able to differentiate between a graphical marker having a first visual feature and a graphical marker having a second visual feature (and preferably associate the visual features with respective relationships between share price rating and share quality rating). Preferably, for each share the graphical marker has the same visual feature across the plurality of charts.

In some embodiments, a set of share categorisations are respectively defined by predefined relationships between share price rating and share quality rating. These categorisations are used for the assignment of visual features. That is, for each share, the visual feature is determined by the share categorisation to which that share belongs. The number of categorisations varies between embodiments. In some embodiments there are only two categorisations (for example “good” and “bad”) whilst in other embodiments there are more than two categorisations.

In some embodiments the set of share categorisations is defined by the following four share categorisations based on a predetermined share quality rating threshold and a predetermined share price rating threshold:
(i) share quality rating above the predetermined share quality rating threshold, share price rating above the predetermined share price rating threshold;
(ii) share quality rating above the predetermined share quality rating threshold, share price rating below the predetermined share price rating threshold;
(iii) share quality rating below the predetermined share quality rating threshold, share price rating above the predetermined share price rating threshold; and
(iv) share quality rating below the predetermined share quality rating threshold, share price rating below the predetermined share price rating threshold.

Conveniently, these categorisations can be represented as quadrants in a two-dimensional chart.

The share price rating threshold is in some cases defined by a zero margin of safety or MOS (such that shares with a positive margin of safety are above the price rating threshold, and shares with a negative MOS are below the price rating threshold). However, other thresholds may be used, optionally depending on principles underlying the overall evaluation and assessment regime. The share quality threshold rating may be defined as a transition between shares assessed or considered to be of “good quality” and shares considered to be of “poor quality”. Such assessment may be based on subjective or objective determinations, qualitative or quantitative inputs, or a combination thereof.

In some embodiments, one of the plurality of charts plots share quality rating against share price rating. An example of such a chart is provided in FIG. 4A, which uses categorizations (i) to (iv) described above. Noting that the visual features of graphical markers are based on the relationship between share price rating and share quality rating, graphical markers having like visual features are grouped in quadrants. These quadrants are defined by the predetermined share quality rating threshold and the predetermined share price rating threshold. In the example of FIG. 4A, those thresholds respectively define the axial origins of the chart. Shares falling into categorisation (i) are shown in the top right quadrant, with outlined-circular graphical markers. Shares falling into categorisation (ii) are shown in the bottom right quadrant, with filled-circular graphical markers. Shares falling into categorisation (iii) are shown in the top left quadrant, with triangular graphical markers. Shares falling into categorisation (iv) are shown in the bottom left quadrant, with square graphical markers.

As noted above, it is in some cases in the interests of clarity, it may be preferable to filter out shares that are deemed to have zero intrinsic value. Similarly, in some embodiments it may be advantageous to omit from display altogether shares that are deemed to have a quality rating below a minimum threshold level considered necessary for any share to qualify as investment grade.

As noted, in the present embodiments, the graphical marker for each share has the same visual feature across the plurality of charts. To illustrate this, a second exemplary chart is illustrated in FIG. 4B. Graphical markers in this chart are still represented by the same shapes, based on the shares' respective categorisations within the quadrants of the chart in FIG. 4A. However, the markers are scattered in a different pattern due to the different assessment dimensions used for the x-axis and/or y-axis in FIG. 4B. In one embodiment, in a chart such as that shown in FIG. 4B, the assessment dimension for the y-axis is share price rating (based for example on margin of safety or MOS) which is the same as the y-axis in FIG. 4A. However, the assessment dimension for the x-axis is changed on the basis of an alternative user-selected evaluation parameter such as market capitalisation, dividend yield, return on equity, debt to equity ratio or the like. Thus, in the chart of FIG. 4B, the positions of the individual shares change relative to their respective positions in the chart of FIG. 4A because of the different assessment dimension used for the x-axis. However, the visual feature(s) such as colour or shape, based on the relationship between the share quality rating and the share price rating, are retained. This effectively provides a third assessment dimension in the chart of FIG. 4B, reflecting for example the quadrant positioning of the respective shares in the chart of FIG. 4A, based on the methodology previously outlined. In this particular example, the vertical positioning of individual shares on the two charts will not change, because in both cases the assessment dimension for the y-axis (MOS) is the same. However, it should be appreciated that in other variations of the chart shown in FIG. 4B, alternative user-selected assessment dimensions (i.e. dimensions other than MOS) may be used for the y-axis, in which case the vertical positioning of particular shares on the two charts may also change.

It should be appreciated that retaining the same visual features across the plurality of charts is particularly useful in terms of facilitating a user's share assessment. For example, the underlying methodology is to acquire, recommend or further analyse shares belonging to categorisation (i), given that they have both a positive margin of safety (i.e. a price below their intrinsic value) and superior quality rating (strong financial performance and minimum risk). A user is thus able to view shares for a range of companies against a set of criteria or assessment dimensions that are of particular interest, such as industry sector, market capitalisation, dividend yield, return on equity, debt to equity, or the like, and readily identify shares that perform well against those criteria based on location on the chart and additionally fall into categorization (i) based on marker shape (or other distinctive visual indicator, such as colour). The user is then able to select a desired share (for example by clicking on that share's marker) and thereby to access additional information regarding that share (such as past and/or projected share price ratings, past and/or projected share value ratings, data corresponding to other assessment dimensions used by one or more of the plurality of charts, and/or other aspects of extrinsic and intrinsic information. A user may also, if s/he so chooses, review the position of that share in a chart such as FIG. 4A so as to better understand where it fits in the upper right quadrant relative to other shares.

It will be appreciated that filters are able to be applied in respect of charts such as those of FIG. 4A and FIG. 4B thereby to reduce the number if graphical markers. These filters may be applied based on substantially any category of information stored in database 110. For example, filters may be applied to show only shares in categorisation (i), shares for companies in a particular sector, shares for companies with a market capitalisation within a specified range, shares exhibiting a return on equity (ROE) above a specified threshold level, shares exhibiting a price to earnings (P/E) ratio below a specified threshold level, debt to equity ratio below a specified level, user-specified shares only, and so on.

### Compound Share Quality Ratings

As noted, database 110 includes a range of information regarding the plurality of shares, including data indicative of a share quality rating. In some embodiments, a compound share quality rating is used. A compound share quality rating is a rating that is inherently indicative of two or more distinct aspects of share quality. In the example discussed below, the compound share quality rating is composed of:
(i) a first share quality rating component indicative of the risk of an adverse liquidity event in the business in respect of which the share is issued; and
(ii) a second share quality rating component indicative of the financial performance of the business.

It will be appreciated that in further embodiments other compound share quality ratings are used, being indicative of these and/or other share quality rating components.

In the present embodiments, one or more first inputs, referred to herein as “risk inputs”, are used for deriving the first share quality rating component, which, as mentioned above, is indicative of risk of an adverse liquidity event in the business. Such adverse liquidity events would include, for example, insolvency, inability of the business to make scheduled loan repayments or to refinance debt, the need to raise additional equity capital in a way that would dilute existing shareholders, or the need otherwise to sell part or all of the business at a sub-optimal time or at sub-optimal value. Such an event would also include the inability of the business to raise sufficient additional debt or equity capital at a particular point in time to take advantage of strategic opportunities. One or more second inputs, referred to herein as “performance inputs” are used for deriving the second share quality rating, which is essentially indicative of the financial performance of the business. A method of according to one embodiment includes combining these distinct first and second share quality rating components to define a compound or composite share quality rating that is independently indicative of both liquidity risk and financial performance.

In some embodiments, the first and second inputs are maintained in database 110. Database 110 optionally specifically maintains, for each share, the first and second share quality rating components (which may be recalculated periodically, optionally with storage of past and/or projected values). In other cases the database only maintains the inputs, and the first and second ratings are calculated by server 100 on demand. Likewise, the compound share quality ratings may be stored in database 110 (and periodically recalculated) or alternately calculated on demand by server 100.

In some preferred embodiments, the first inputs include a parameter (A) indicative of a return on assets for the business associated with each share, a parameter (B) indicative of a ratio of total sales to total assets for the business associated with each share, and a parameter (C) indicative of a debt to equity ratio for the business associated with each share. Values (preferably being normalized values) for these parameters are used as inputs in a weighting algorithm thereby to derive the first share quality rating component. Preferably the weighting algorithm operates such that parameter (A) is weighted more heavily than parameter (B) and parameter (B) is weighted more heavily than parameter (C).

In some embodiments, the second inputs include a parameter (D) indicative of return on equity for the business associated with each share, a parameter (E) indicative of cash return on assets for the business associated with each share, and a parameter (F) indicative of change in shares on issue over time for the business associated with each share. Optionally, the second inputs include a further parameter (G) indicative of a debt to equity ratio for the business associated with each share. Values (preferably being normalized values) for these parameters are used as inputs in a weighting algorithm thereby to derive the second share quality rating component. Preferably the weighting algorithm operates such that parameter (D) is weighted more heavily than parameters (E) and (F).

The first share quality rating component is preferably defined relative to a first share quality rating scale. That is, a share quality rating scale is determined, and the first share quality rating component is defined relative to that scale. Likewise, the second share quality rating component is preferably defined relative to a second share quality rating scale, and the compound share quality rating defined relative to a compound share quality rating scale. The use of such scales facilitates a relative comparison of multiple shares against common criteria. For instance, the compound share quality rating scale may provide an assessment dimension for an axis of one or more charts (such as the x-axis on the charts of FIG. 4A, 4B or 4C). In this regard, some embodiments include methods characterized by a step of generating a chart having an axis representative of the compound share quality rating scale.

In some embodiments the compound share quality rating scale is graduated primarily on the basis of the first share quality rating and secondarily on the basis of the second share quality rating, such that the first share quality rating is weighted relatively more heavily than the second share quality rating. As a specific example, one compound share quality rating is defined by two values in the following format:

(first share quality rating component)(second share quality rating component)

In a straightforward example, the first share quality rating component is defined on a scale ranging from A to C, and the second share quality rating component is defined on a scale ranging from 1 to 5. Accordingly, graduation of the compound scale based on relatively higher weighting of the first share quality rating results in the following scale:

A1, A2, A3, A4, A5, B1, B2, B3, B4, B5, C1, C2, C3, C4, C5

This makes use of a compound share quality rating displayed by a first symbolic identifier indicative of the risk of an adverse liquidity event in the business (A, B or C) and a second symbolic identifier indicative of the financial performance of the business (1, 2, 3, 4 or 5).

The above example presents a relatively limited scale, with minimal graduation between values (there being only 9 values in total). Some embodiments provide more extensive scales, optionally in combination with a simplified set of categorizations. For example, the first symbolic identifier is selected from a first set of potential symbolic identifiers, wherein each of the potential symbolic identifiers in the first set is associated with a predefined range of first share quality ratings, and the second symbolic identifier is selected from a second set of potential symbolic identifiers, wherein each of the potential symbolic identifiers in the second set is associated with a predefined range of second share quality ratings.

By way of example, the first share quality rating component may be defined on a scale of 1 to 300, and a value of between 1 and 100 is associated with A, a value of between 101 and 200 is associated with B, and a value of between 201 and 300 associated with C. Likewise, the second share quality rating component may be defined on a scale of 1 to 500, and a value of between 1 and 100 is associated with 1, a value of between 101 and 200 is associated with 2, a value of between 201 and 300 associated with 3, value of between 301 and 400 associated with 4, value of between 401 and 500 associated with 5. In both cases, these scales assume a lower value represents higher quality.

The use of letters and numbers to define the compound rating is by no means exclusive. For example, in some cases one of the first and second symbolic identifiers is a symbol and the other of the first and second symbolic identifiers is a visual characteristic applied to that symbol (such as a colour). For example, in one implementation, the first share quality rating component is designated on the basis of a selection from the letters A, B and C (with A denoting minimum risk and C denoting maximum risk as determined by an algorithm based on the pre-defined risk inputs) and the second share quality rating component is designated on the basis of a selection from the colours green, orange and red (with green denoting strongest financial performance and red denoting relatively weakest financial performance as determined by an algorithm based on the pre-defined performance inputs). Thus, the display of a compound share quality rating in the form of the letter A associated with the colour green (for example a green font used for the letter itself, green highlight around the letter, or some other green visual designation associated with the letter) would indicate a business of the highest quality, as assessed with reference to both liquidity risk and financial performance. By contrast, a compound share quality rating in the form of the letter C associated with the colour green, would indicate similarly strong financial performance but substantially increased liquidity risk.

In some cases, one of the first and second symbolic identifiers is a first symbol having a first visual characteristic, and the other of the first and second symbolic identifiers is a second symbol having a second visual characteristic (for example the first and second visual characteristics include colour, determined on the basis of the respective first or second share quality rating components). For example, one embodiment uses a common symbol R for the first share quality rating component component, and this is shaded in a predetermined color depending on the value for the first component. Hence, a green R represents a relatively low risk, and a red R represents a relatively high risk in terms of the first component (relating to liquidity risk). Similarly, colouring of a common symbol, for example P, may be used to indicate relative quality or strength in terms of the second component (relating to financial performance).

The use of a simplified set of categorizations as discussed above allows the compound share quality rating to be displayed to a user in a relatively coarse form using the symbolic identifiers, and also displayed on a chart with more granularity using the first share quality rating and second share quality rating. By way of example, in the context of FIG. 4C, the graphical markers 401 to 407 are at different points along the x-axis of the graph (this x-axis representing the compound share quality rating), but nevertheless are associated with the same symbolic identifiers (for example these may all be regarded as A1 quality shares using the symbolic identifiers). This is useful in the sense that symbolic identifiers provide a coarse categorization of a business based on the compound quality rating, whereas the precise position on the chart allows for high granularity and detailed comparison (enabling, for example, comparison of which A1 shares are of better relatively quality than others, which would be in this example those further to the right along the x-axis, assuming marker 408 represents an A2 share).

As noted above, for the purposes of charting the first and second share quality rating components may be given different weightings according to the specific algorithm employed, which may be tailored for particular purposes, preferences or investment styles. In one embodiment, the distribution of shares along the quality axis is based solely on the first quality rating component (e.g. corresponding to symbolic identifiers A, B, or C in the example previously described). This means that the second quality rating component (e.g. corresponding to symbolic identifiers 1, 2, 3, 4 or 5 in the example previously described) is effectively zero-rated for this particular purpose (but may nevertheless be significant and highly valuable for other charting or analytical purposes).

In this embodiment, underlying each first share quality rating (e.g. A, B or C) is a specific numerical value which can be finely graduated according to the particular algorithm employed, based on the set of first inputs of the type previously described. At pre-defined threshold transition points, corresponding to specific values on a pre-defined scale, the symbolic identifier corresponding to the first share quality rating changes from one level to the next (e.g. an A rating becomes a B, a B becomes a C, a B becomes an A, etc). In this embodiment, it is these underlying numerical values for the first quality rating component, which are used as a basis for accurately positioning the shares along the quality axis in the chart, with a high degree of precision and resolution, without compromising the simplicity of the overlying quality rating scheme and the associated symbolic identifiers. Of course, in some other embodiments, the symbolic identifiers for one or both of the share quality rating components may simply mirror the underlying numerical values.

This compound share quality rating methodology and the related charting functionality provide a number of significant advantages. Irrespective of the particular form that the constituent share quality rating components may take, the compound share quality rating maintains separate, distinct and independent indicators of both the risk and performance attributes of the underlying business. This is important because some businesses may generate strong financial returns in favourable conditions, but a consideration of financial returns alone may overlook significant underlying risks, such as the risk of insolvency due to excessive levels of gearing or debt. Conversely, some businesses may generate relatively moderate financial returns, but a consideration of this factor alone may overlook the fact that the business may generate these returns with minimal volatility and financial risk, for example by consistently generating strong positive cash flows and carrying minimal or no debt. What is important from a value investor's perspective is risk-adjusted financial performance. This allows performance to be viewed in the context of concomitant risk, and allows investment decisions to be matched to the investor's own risk profile, in the context of wider portfolio considerations.

The compound share quality rating methodology as proposed provides a simple, intuitive, yet very powerful way of analysing and presenting the necessary information at a high level, allowing investors to rank businesses on these fundamentally important metrics of risk and return, and facilitating better informed investment decisions. It also allows investors to readily identify rare businesses in an elite group, offering the potential for both strong financial performance and (relatively) low risk. At the same time, it allows investors to readily identify and hence avoid poor quality businesses characterised by weak financial performance and/or comparatively high risk, which is just as important from a value investment perspective as the identification of superior quality businesses.

### Exemplary Web-Delivery Framework

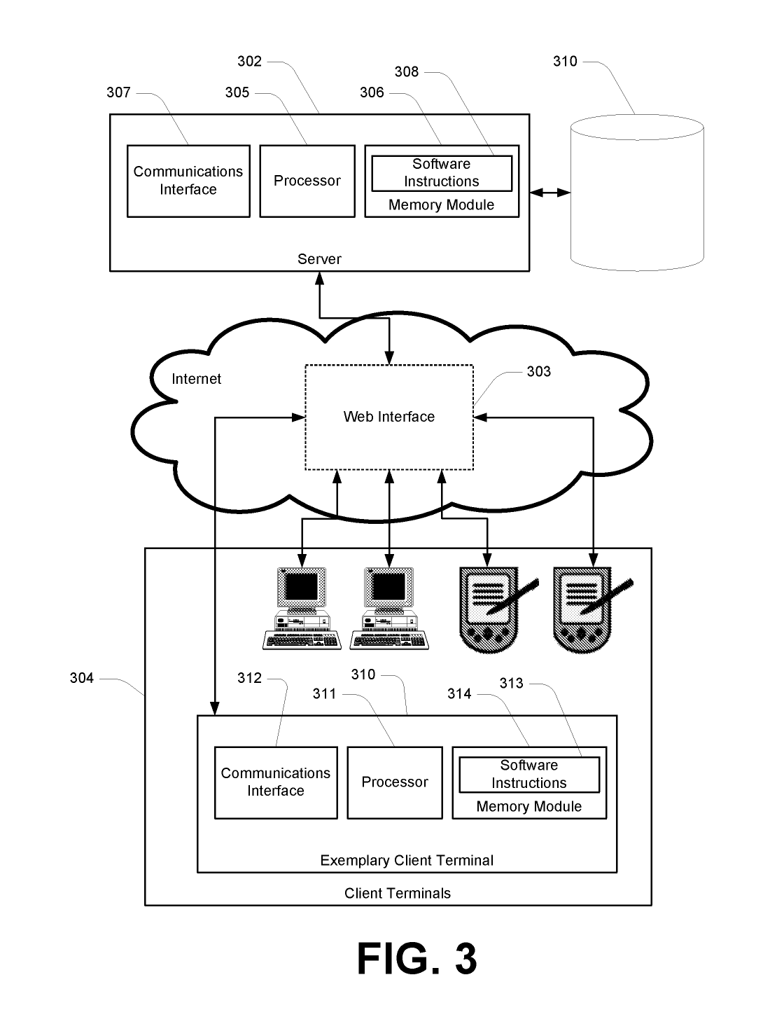

In some embodiments, methods and functionalities considered herein are implemented by way of a server, as illustrated in FIG. 3. This figure, and the following explanation, is provided as additional context to web delivery frameworks. In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310. In further embodiments the database leverages memory module 306.

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a client interface and allow communication with server 302. This client interface allows for the creation, viewing and administration of profiles, access to the internal communications interface, and various other functionalities.

### CONCLUSIONS AND INTERPRETATION

It will be appreciated that the disclosure above provides various significant systems and methods for providing share assessment data. For example, by providing charts in which shares are each visually represented by a respective graphical marker, with each visual marker bearing a visual feature indicative of the relationship between the relevant share's price rating and value rating, it is possible for a user to quickly and conveniently identify shares that are appropriate for a given investment strategy, or at least warrant short-listing for further analysis.

Unless specifically stated otherwise, throughout the specification terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1.-31. (canceled)

32. A computer-implemented method for providing share assessment data, the method including:
maintaining access to a repository of data for a plurality of shares in respective businesses, wherein the data includes, for each share:
(a) one or more first inputs for deriving a first share quality rating component indicative of risk of an adverse liquidity event in each business; and
(b) one or more second inputs for deriving a second share quality rating component indicative of financial performance of each business; and
combining the first share quality rating component and the second share quality rating component thereby to define a compound share quality rating that is independently indicative of both liquidity risk and financial performance for each of the respective businesses.

33. The computer-implemented method of claim 32, wherein the first inputs include a parameter (A) indicative of a return on assets for the business associated with each share.

34. The computer-implemented method of claim 33, wherein the first inputs include a parameter (B) indicative of a ratio of total sales to total assets for the business associated with each share.

35. The computer-implemented method of claim 34, wherein the first inputs include a parameter (C) indicative of a debt to equity ratio for the business associated with each share.

36. The computer-implemented method of claim 35, wherein the first inputs are weighted, such that parameter (A) is weighted more heavily than parameter (B) and parameter (B) is weighted more heavily than parameter (C).

37. The computer-implemented method of claim 32, wherein the second inputs include a parameter (D) indicative of return on equity for the business associated with each share.

38. The computer-implemented method of claim 37, wherein the second inputs include a parameter (E) indicative of cash return on assets for the business associated with each share.

39. The computer-implemented method of claim 38, wherein the second inputs include a parameter (F) indicative of change in shares on issue over time for the business associated with each share.

40. The computer-implemented method of claim 39, wherein the second inputs include a parameter (G) indicative of a debt to equity ratio for the business associated with each share.

41. The computer-implemented method of claim 39, wherein the second inputs are weighted, such that parameter (D) is weighted more heavily than parameters (E) and (F).

42. The computer-implemented method of claim 32, wherein the first share quality rating component is defined relative to a first share quality rating scale.

43. The computer-implemented method of claim 32, wherein the second share quality rating component is defined relative to a second share quality rating scale.

44. The computer-implemented method of claim 32, wherein the compound share quality rating is defined relative to a compound share quality rating scale.

45. The computer-implemented method of claim 44, wherein the compound share quality rating scale provides an assessment dimension for an axis of one or more charts.

46. The computer-implemented method of claim 45, further comprising:
generating a chart having an axis representative of the compound share quality rating scale.

47. The computer-implemented method of claim 44, wherein the compound share quality rating scale is graduated primarily based on the first share quality rating and secondarily based on the second share quality rating, such that the first share quality rating is weighted relatively more heavily than the second share quality rating.

48. The computer-implemented method of claim 32, wherein the compound share quality rating is displayed by a first symbolic identifier indicative of the risk of an adverse liquidity event in the business and a second symbolic identifier indicative of the financial performance of the business.

49. The computer-implemented method of claim 48, wherein, for a given share, the first symbolic identifier is selected from a first set of potential symbolic identifiers, wherein each of the potential symbolic identifiers in the first set is associated with a predefined range of first share quality ratings.

50. The computer-implemented method of claim 48, wherein, for a given share, the second symbolic identifier is selected from a second set of potential symbolic identifiers, wherein each of the potential symbolic identifiers in the second set is associated with a predefined range of second share quality ratings.

51. The computer-implemented method of claim 48, wherein one of the first and second symbolic identifiers is a letter and the other of the first and second symbolic identifiers is an integer.
